(19) United States
(12) Patent Application Publication
(10) Pub. No.: US 2003/0076816 A1
(43) Pub. Date: Apr. 24, 2003

(54) Automatic route selection

(75) Inventors: Peter Naranjo, Merrimack, NH (US); David Y. Schlossman, Burlingame, CA (US)

Correspondence Address: ELMER GALBI, 13314 VERMEER DRIVE, LAKE OSWEGO, OR, 97035

(73) Assignee: At Comm Corporation, San Mateo, CA

(21) Appl. No.: 10/133,544

(22) Filed: Apr. 26, 2002

Related U.S. Application Data
(60) Provisional application No. 60/286,864, filed on Apr. 26, 2001.

(51) Int. Cl. H04L 12/66

(52) U.S. Cl. 370/352; 370/389

(57) ABSTRACT

An Automatic Route Selection (ARS) method and system for telephone calls. Routing is based upon a variety of factors using both digit analysis and table lookups. Calls are routed based on factors such as call type, call priority, and actual call costs defined in a rate table. With the present invention routing based on a variety of factors can be applied by the system administrator to achieve a cost efficient and cost-effective routing plan. An important factor that is used to route calls is the profile of the caller's history of usage. With a sliding window of recent calls, it is possible to estimate the expected hold time (duration) of a new call being placed in order to determine the most cost-effective route for that call.

### RELATED APPLICATION

This application is a non-provisional application of provisional application 60/286,864 filed Apr. 26, 2001. Priority of application No. 60/286,864 is claimed.

### FIELD OF THE INVENTION

The present invention relates to communications systems and more particularly to telephone systems.

### BACKGROUND OF THE INVENTION

Telephone switching is a well developed technology. Telephone switches are designed to route voice calls on a point to point basis. The technology for connecting computers into networks is also well developed. Computers networks such as local area networks (LANS) and wide area network (WANS) use packet routers and switches which are designed to route and switch data packets. Historically, the telephone systems and LANS in offices were entirely separate systems. Recently, there has been a growing tendency to integrate telephone systems and LANS. For example, co-pending patent application Ser. No. 09/527,968 filed Mar. 17, 2000 entitled “Integrated Scalable PBX and Router with Pooling” describe an integrated system that provides the functions of both a telephone PBX and an Ethernet data router. Systems such as that shown in co-pending application Ser. No. 09/527,968 include a programmable computer which allows one to route calls according to a stored program.

### SUMMARY OF THE PRESENT INVENTION

The present invention provides Automatic Route Selection (ARS) for calls placed by a variety of users. Routing is based upon a variety of factors using both digit analysis and table lookups. Calls are routed based factors such as call type, call priority, and actual call costs defined in a rate table. With the present invention, routing based on a variety of factors, can be applied by the system administrator to achieve an efficient and cost-effective routing plan. An important factor that is used to determine the route of a particular call is a profile of a caller's history of usage. With a sliding window of recent calls to specific phone numbers, it is possible to estimate the expected hold time (duration) of a new call being placed in order to determine the most cost-effective route for that call.

### DESCRIPTION OF FIGURES

FIG. 1 is an overall system diagram of a system utilizing the present invention.

FIG. 2 is a program flow diagram of the operation of the present invention.

FIG. 3 is a flow diagram of the program that determines the calling patterns of users.

FIG. 4A and 4B are a program flow diagram illustrating routing based upon a user profile.

FIGS. 5A and 5B are a program flow diagram illustrating routing based on priority.

### DETAILED DESCRIPTION

In order to facilitate an explanation of the invention a number of terms will be defined. Many of the defined terms are terms of art regularly used in the telephone industry in connection with call accounting products. For example many of the terms given below are used in connection with a product known as “CommView” which is commercially marketed by the AtComm Corporation of Burlingame Calif. In the following description the following terms have the meaning given below:

Call Type—The call type is defined based on the jurisdiction of the call. After the breakup of AT&T in 1984 telephone call were classified calls into local carrier (LEC) and inter-exchange carrier (IXC) jurisdictions. The LEC's domain was defined within the Local Access Transport Area (LATA). The IXC's domain was defined as calls carried across LATA or state boundaries. These boundaries apply to the North American dialing plan only and are not applicable for international locations.

Within the LATA there are two classifications of calls: local and local toll. While most commercially marketed rate tables, such as those marketed by AtComm Corporation, rate both local and local toll calls, there is no call type distinction between the two (ie, both are call type 11). This is due to the variety of ways local calls are priced in different parts of the country. Some areas use a single flat-rate to price all local calls. Other areas use a mileage-based zone pricing scheme. Still other areas use a non-mileage-based zone pricing scheme.

Within the IXC's domain for domestic long-distance there are 4 classifications of calls: Interstate/InterLATA, Intrastate/InterLATA, Intrastate/IntraLATA, Interstate/IntraLATA. Other call types addressed for non-domestic calls are Canada, Puerto Rico and the Virgin Islands, and other international countries.

LEC—Local Exchange Carrier—The LEC is also known as the local telco or phone company. The Regional Bell Operating Companies (RBOCs) are the most common telcos in the US. These include Bell Atlantic (Nynex), Bell South, Ameritech, US West, SBC Communications (formerly PacTel and Southwestern Bell). Independent Operating Carriers (IOCs) and Competitive Local Exchange Carriers (CLECs) compete with the incumbent LECs.

IXC—Inter-exchange Carrier—Long distance carriers such as AT&T, Sprint, and MCI Worldcom.

Peak Hours—identifies the period of time during the 24-hour day when a carrier's “peak rates” apply. Typically, the peak time is assigned to the business day hours (8 am-5 pm). Off-Peak Hours—identifies the period of time during the 24-hour day when a carrier's “off-peak rates” apply. Typically, the off-peak time is assigned to the non-business day hours (5 pm-8 am).

Initial Peak Period—identifies the initial period of time used to measure the rate of a call carried during peak hour. Periods may be expressed in minutes (e.g., 1 min., 3 min.) or seconds (e.g., 60 secs., 6 secs.)

Overtime Peak Period—identifies the additional periods of time following the initial period used to measure the rate of a call carried during peak hour. Periods may be expressed in minutes (e.g., 1 min., 3 min.) or seconds (e.g., 60 secs., 6 secs.). Overtime periods are often, but not always shorter periods than the initial periods. As an example, the initial period may be 1 minute and the overtime period may be 6 seconds.

Initial Off-Peak Period—identifies the initial period of time used to measure the rate of a call carried during off-peak hour. Periods may be expressed in minutes (e.g., 1 min., 3 min.) or seconds (e.g., 60 secs., 6 secs.).

Overtime Peak Period—identifies the additional periods of time following the initial period used to measure the rate of a call carried during peak hour. Periods may be expressed in minutes (e.g., 1 min., 3 min.) or seconds (e.g., 60 secs., 6 secs.). Overtime periods are often, but not always shorter periods than the initial periods. As an example, the initial period may be 1 minute and the overtime period may be 6 seconds.

Rate Table—Commercially marketed proprietary information that contains rate information for a variety of carriers including the incumbent LEC and one or more IXCs. Rate tables are prepared by companies such as AtComm and delivered to call accounting customers in a variety of options. One common commercially used rate table format is designed for use with the AtComm product marketed under the name “CommView”. Rate tables are generally delivered to the customer via dial-up modem using secure authentication. Rates can also be delivered to customers over secure IP connections.

Time-Of-Day—(1) identifies the time of day a call occurred. This is referenced as the start time of the call; (2) TOD is sometimes used to refer to the call type (local, Interstate/InterLATA, etc.).

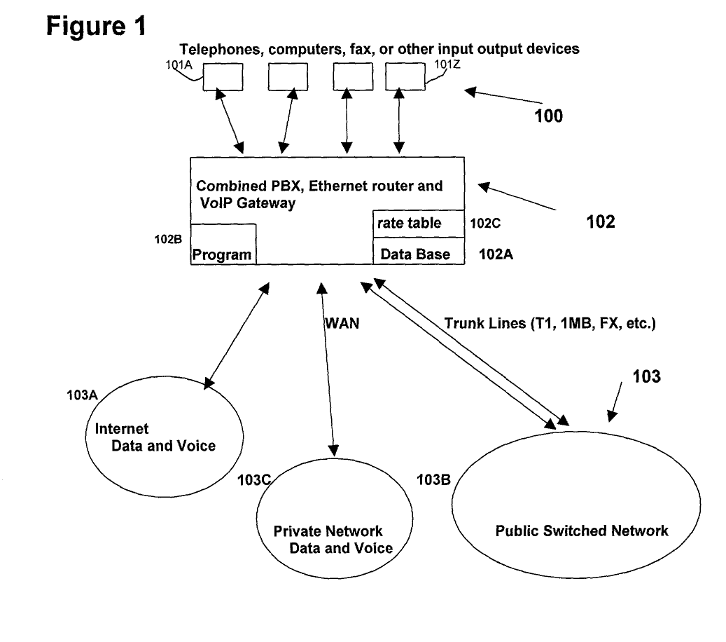

FIG. 1 is a block diagram of a first preferred embodiment of the present invention. As illustrated in FIG. 1, there are three main parts to the system. First, there is a variety of input-output devices or terminals 101, second there is a combined PBX and data router 102, and third, there are a variety of external networks 103.

The combined PBX data router 102 can for example be the system unit shown in co-pending application Ser. No. 09/527,968 filed Mar. 17, 2000 entitled “Integrated Scalable PBX and Router with Pooling”. Co-pending application Ser. No. 09/527,968 describes an integrated system that provides the functions of both a telephone PBX and an Ethernet data router. The content of co-pending application Ser. No. 09/527,968 is hereby incorporated herein by reference. Alternatively unit 102 can some other available programmable PBX. By providing a combined PBX and data router additional facilities are available to the system administrator. The present invention is implemented by computer programs 102B which are stored in unit 102.

The input-output devices 101 can be telephones connected to ports on unit 102 by normal telephone lines, computers connected to ports on unit 102 by LAN connections such as by Ethernet connections, or they can be other types of input-output units such as fax units connected to appropriate ports on unit 102. For convenience of illustration only four input devices 101A to 101Z are shown. In a typical system there would be many such input devices. For example a system with fifty such input-output devices would not be unusual.

The networks 103 are networks such as the conventional public switched network 103B, Internet network 103A which can handle data and Internet telephone calls, and private network 103C which can handle voice and data. Network 103B is connected to unit by 102 by connections such as trunk lines, T1 lines or other types on conventional telephone system connections. The Internet network 102A is the widely available Internet network which can be connected to unit 102 by a wide variety of available connections . Generally a connection to the Internet is through a commercial Internet Service Provider (ISP), many of which are available. Finally the system can be connected to a private data and voice network 103C. Such a connection would generally be through an Ethernet port on unit 102.

When the system receives a request from a user to place a call, the system has a wide variety of alternatives available. It can place the call over traditional telephone lines as is done with a conventional PBX or as a voice over IP call. The system can have a wide variety of different telephone services available via the public switched network. The task the present invention performs is to choose the most cost effective service consistent with other requirements for each call.

Each particular system will have a variety of alternatives available. One alternative is to send calls on a packetized basis over a data network as Voice over IP (VoIP). VoIP technology is known. These alternatives are established by a system administrator (from those available on the particular system) when the system is installed or at a later time. If one route is busy (fully occupied), the call can be sent over an alternative route. Route selection is based on a variety of factors including expected call length and the priority of the particular call.

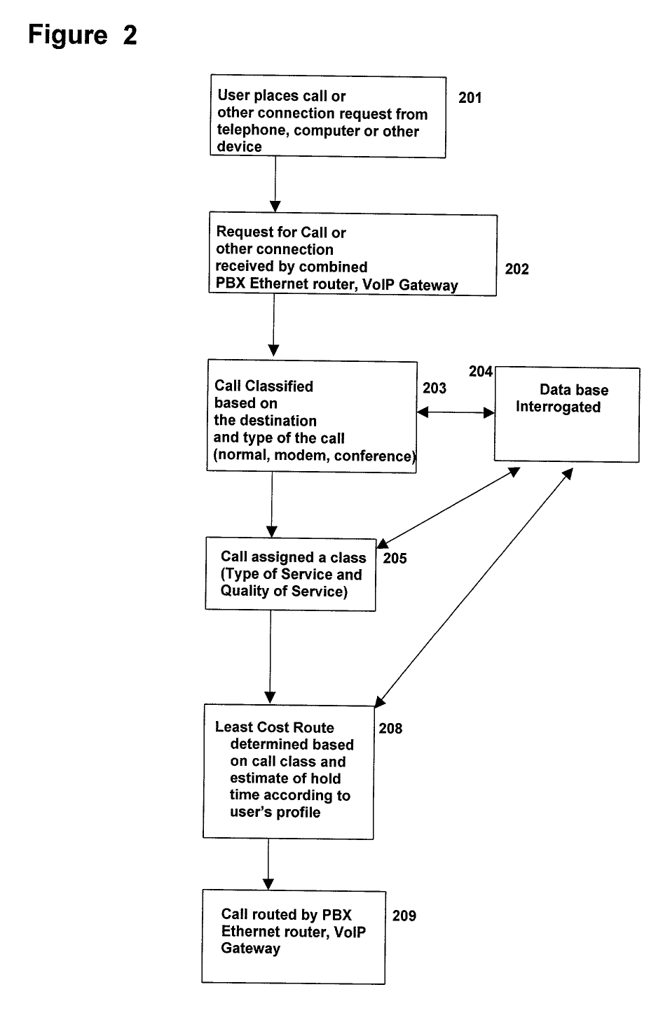

Unit 102 is programmable and it includes programs 102B, a data base 102A which stores user and system information and a rate table 102C. Block flow diagram of programs 102B are given in FIGS. 2 to 5.

Programs 102B operate as follows: As indicated by block 201, the process begins when a user places a call or when the user sends a connection request via a computer terminal. Alternatively the connection request can be from another input-output unit such as a fax machine or video conference machine. Each unit 101 is connected to unit 102 via a particular port, hence, as indicated by block 202, when unit 102 receives a request it determines from its data base 102A, the characteristics of the unit that placed the request.

As indicated by block 203, each call is classified based upon the type of the call and the destination of the call. As indicated by block 204, data base 102A is interrogated in order to make this classification. As indicated by block 205, each call is assigned a class. The class of a call determines the type and quality of the service that will be provided. It also determines the priority for that call in relationship to other call types.

The least cost route is determined as indicated by block 208 and the call is routed as indicated by block 209. The route is determined by the class of the call and the profile of the user that made the call. For example, if a user usually makes very short calls to a particular dialed number, a route may be selected which measures calls in short increments, even though the cost per increment may be higher than other routes. On the other hand if a user usually makes long calls, a route with a low cost per increment will be selected even though the length of the increments may be longer.

The fact that it may be less expensive to select a route with a higher per second cost in certain situation is given below. The factor that must be considered in addition to the per second cost is the measurement increment. It should be understood that the numbers given below are merely an example and rate tables can provide a wide variety of alternatives. This following table provides a simple illustration.

| | Length | Route of | Measurement | Cost per | Total |
|---|---|---|---|---|---|
| | of Call | Call | Increment | Minute | cost |
| Call A | 1.5 | Route 1 | ten seconds | .03 cent | $1.89 |
| | minute | Route 2 | one minute | .02 cent | $3.60 |
| Call B | 5 | Route 1 | ten seconds | .03 cent | $9.00 |
| | minutes | Route 2 | one minute | .02 cent | $6.00 |

As illustrated about, for call A, route 1 is less expensive even though the per second cost is higher. Thus in routing a call, the expected length of the call is an important factor in determining the lowest cost route.

The rate table 102C can for example be the rate table which is commercially available from At Comm corporation and which is updated monthly on a subscription basis. In the case of the rate tables commercially available from Atcomm, rates are updated monthly on a server (the At Comm “CommView Server”) and are available for download to eligible customers at any time.

The program 102B requires three types of information in order to classify and route calls. The first type of information is the rate table information which is provided by table 102C. The second type of information is information about the nature of the input-output devices from data base 102A. The information about the various input-output devices can be loaded into the data base 102A by the system administrator or alternatively there are programs available that can automatically interrogate devices to determine this type of information.

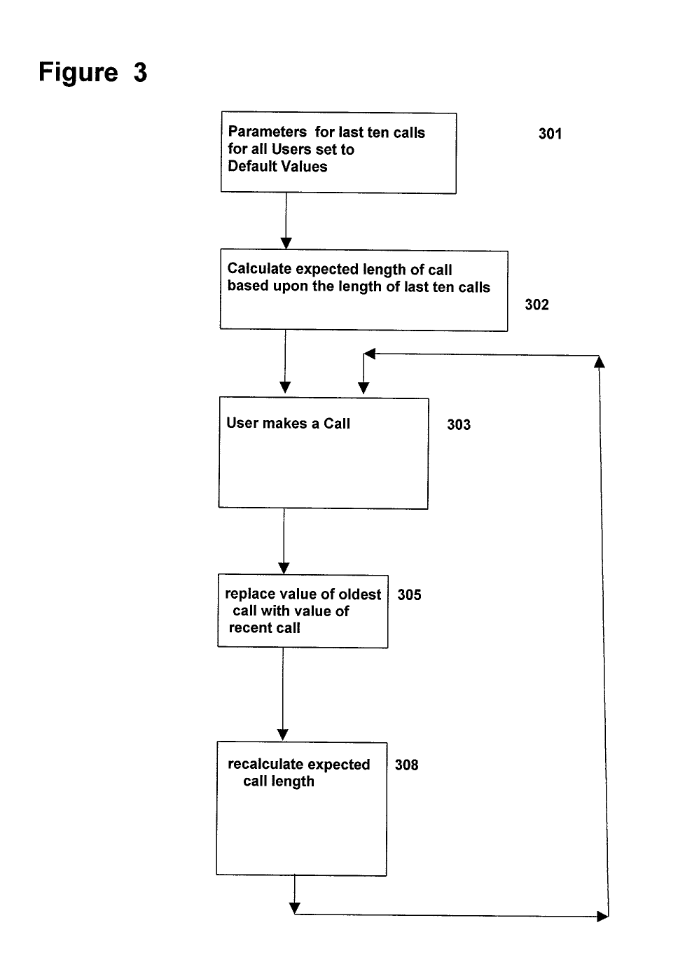

The third type of information which program 102B needs is information about the typically calling patterns of users. FIG. 3 is a block diagram of a program for determining the typically calling patterns of users. This particular program detects a pattern in the last ten calls made by a user. Naturally various other techniques for detecting a pattern in the calls made by a user can be used in place of the relatively simple process illustrated in FIG. 3. The object of the program is to determine the expected length of calls by a particular user. In other embodiments, more complicated pattern can be determined.

The program begin as indicated by block 301, by assigning a default set of characteristics. That is, the user is assumed to have made ten calls having a length set to a default value. For example the default length could be five minutes. It is noted that a calling pattern can be determined by examining a certain number of calls. In the example illustrated in FIG. 3, a calling pattern is determined by examining the last ten calls made by a user. Initially all ten calls are set to a default value as indicated by block 301. Each time as call is made the oldest previous call is deleted and the characteristics of the new call replaces the deleted call as indicated by 303. The parameters for that user are then updated. In the example illustrated the parameter is the expected length of a call. In more complex situations the parameters calculated can be more complex. As shown in FIG. 3, calls to any number are grouped together. In other embodiments, the profile could be more granular. For example, a separate profile could be established for call to each particular telephone number, or to each area code, or to each group of area codes that is frequently called by the particular user. In still other embodiments, a separate profile is established for a group of frequently called area codes. The expected length of a call is calculated as indicated by block 302. After the user makes a call as indicated by block 303, the oldest previous value is reset to the more recent value as indicated by block 305. The expected length is then recalculated as indicated by block 308. The process is repeated when the user makes another call as indicated by block 303.

In general the technology is known for calculating various parameters from call history. For example see issued U.S. Pat. No. 6,185,145 which shows how patterns in calls can be calculated. The first embodiment of the present invention calculates the expected call length from the call history. It is noted that in alternative embodiments, additional factors used call routing can also be calculated from call history.

With the preferred embodiment of the present invention calls are divided into Priority-1 Routing and Priority-2 routing. It should be understood that each embodiment will have its own priority arrangement.

Priority-1 Routing is accepted as the top priority routing scheme for any calls offered to the switch matching criteria defined in this category. If the preferred Priority-1 route is not available, an optional attempt is made to route the call using the next matching Priority-1 route. If there are no more matching Priority-1 routes, an optional attempt is made to route the call using the first matching Priority-2 route, and so on.

Priority-1 routes are defined based on digits dialed. Priority-1 routes are expected to handle situations where carrier services have been assigned/contracted to handle specific types of calls. Examples of these types of calls are: ISDN BRI dialup connections to an ISP, Tie Lines (T1) to remote offices, or international calls handled under a special rating plan by a carrier different than the one used for domestic calls.

Priority-1 calls do not require any specific pricing information. They are identified based on the digits dialed by the person placing the call.

The Priority-1 table is limited to X number of table entries to be determined. A minimum of 64 entries is expected to be supported.

| Trunk | Dial Access | | Insert | Overflow |
|---|---|---|---|---|
| Group(s) | Code | Dialed Number | Digits | Permitted |
| Selected | Different dial | Any sequence of | This | Yes/No |
| from a list | access codes | digits following the | option | Selecting |
| of trunk | may be used | dial access code | allows the | “yes” |
| groups | to influence | such as: | adminis- | continues |
| available | the call | 011 - any int'l call | trator to | search |
| to unit 102 | routing. | 01144 - any call to | identify | for next |
| in order of | Typically 9 is | UK | specific | Priority-1 |
| prece- | used for PSTN | 01144778 - any call | digits to | match if |
| dence. | calls. 8 or 7 | to a specific city | be | circuit is |
| The defi- | for on- | in the UK | inserted | not |
| nition ex- | net/ESN calls. | 1650 - any call to | into the | available. |
| ists to the | Numbers | area code 650 | outpulsed | The last |
| granularity | dialed without | 1650375 - any call | digits. | criteria |
| of trunk | an access | to the 375 prefix in | This | matched |
| group. If | code should | 650 | provides a | in |
| more than | be attempted | 16503758188 - any | convenient | Priority-1 |
| one circuit | to be | call to a different | and | may |
| is | completed as | office of the com- | flexible | overflow |
| available | station-to- | pany that owns the | way to | to |
| in the | station calls. | unit. | automate | Priority-2 |
| trunk | In this case | 375 - any call to the | remote | list under |
| group, | insert digits | local prefix 375 | office DID | “yes” |
| Unit 102 | option can still | 3751111 - any call | speed | condition |
| hunts | be used to | to a local number | dialing, | and |
| based on | place a call | 375xxxx - permits | routing to | circuit not |
| its | over the | wildcard to require | alternate | available |
| previously | PSTN. | 7 digits dialed | equal | |
| defined | The | where each last 4 | access | |
| hunt | administrator | digits can be any | carriers | |
| algorithm | can define any | digit 0-9 - this may | (101xxxx) | |
| for that | access codes | avoid conflicts be- | or other | |
| group | as needed - | tween NPAs and | applica- | |
| (terminal | the default | NXXs where 1+ | tions. | |
| or | access code is | dialing is not | | |
| circular). | 9 for PSTN | required | | |
| | access. | Wildcard characters: | | |
| | Access codes | ‘x’ - any digit 0-9 | | |
| | should support | ‘n’ - any digit 2-9 | | |
| | at least 2- | | | |
| | digits. | | | |

Priority-1 Routing Examples

| | Dial | | | | |
|---|---|---|---|---|---|
| Trunk | Access | Dialed | Insert | Overflow | |
| Group(s) | Code | Number | Digits | Permitted | Comment |
| Group 3 - | 9 | 3128200 | | No | ISP access to |
| ISDN BRI | | | | | shared LAN |
| | | | | | Internet |
| | | | | | account over |
| | | | | | dialup |
| | | | | | BRI circuit. |
| Group 10 - | | 5xxx | 16505 | No | Implements a |
| MCI T1 | | | 48 | | convenient |
| | | | | | system-wide |
| | | | | | speed dial |
| | | | | | mechanism to |
| | | | | | call a remote |
| | | | | | office with |
| | | | | | exts. 5000- |
| | | | | | 5999. Assumes |
| | | | | | a coordinated |
| | | | | | dialing plan |
| | | | | | between sites |
| | | | | | in the |
| | | | | | enterprise. |
| Group 13 - | 21 | 011 | | | Special Int'l |
| INTL A1 | | | | | carrier group |
| | | | | | for special |
| | | | | | business calls |
| | | | | | to Pacific Rim |
| Group 11 - | 9 | 011 | | Yes | All |
| AT&T T1 | | | | | international |
| | | | | | calls are |
| | | | | | attempted to be |
| | | | | | carried by |
| | | | | | preferred |
| | | | | | carrier |
| | | | | | (AT&T). If all |
| | | | | | circuits are |
| | | | | | busy, other |
| | | | | | trunk groups |
| | | | | | may be used |
| Group 10 - | 9 | 011 | | Yes | Alternate |
| MCI T1 | | | | | carrier for int'l |
| | | | | | calls |
| Group 10 - | 9 | 1 | | Yes | Preferred |
| MCI T1 | | | | | carrier for |
| Group 11 - | | | | | domestic LD |
| AT&T T1 | | | | | call (MCI), |
| | | | | | followed by |
| | | | | | alternate carrier |
| | | | | | (AT&T) |
| Group 10 - | 9 | nxxnxxx | 1 | Yes | Any 10-digit |
| MCI T1 | | xxx | | | number |
| Group 11 - | | | | | following |
| AT&T T1 | | | | | NANP |
| | | | | | guidelines for |
| | | | | | LD matches |
| Group 2 - | 9 | 1nxxnxx | 10103 | No | Default equal |
| PacBell CO | | xxxx | 21 | | access carrier |
| | | | | | for all |
| | | | | | domestic call |
| | | | | | types |
| Group 2 - | 9 | 911 | | Yes | |
| PacBell CO | | | | | |
| Group 2 - | | 911 | | Yes | No dial access |
| PacBell CO | | | | | required for |
| | | | | | 911 |
| Group 2 - | 9 | nxxxxxx | | No | All local traffic |
| PacBell CO | | | | | routed over |
| | | | | | LEC |

Default Priority-1 Routing Table with BRI

If a BRI circuit is enabled, the user may elect to setup a table similar to the example below. This provides overflow for voice calls from the COTs to the BRI circuits if they are not in use for data.

Since no dialed numbers are defined in this example, all calls will be routed to the COT as first choice. This should be modified or deleted whenever a Priority-2 Table or Call Type Override Table is defined by the administrator to allow the Priority-2 table to select the proper least-cost route for each call.

| | Dial | | | | |
|---|---|---|---|---|---|
| Trunk | Access | Dialed | Insert | Overflow | |
| Group(s) | Code | Number | Digits | Permitted | Comment |
| Group 0 - | 9 | | | Yes | Default CO trunk |
| COT | | | | | group 0 for base |
| | | | | | unit's 4 CO circuits |
| | | | | | used for all inbound/ |
| | | | | | outbound local + |
| | | | | | toll calls |
| Group 1 - | 9 | | | No | If BRI is available, |
| BRI | | | | | trunk group 1 can |
| | | | | | serve as overflow |
| | | | | | from group 0 as |
| | | | | | well as service data |
| | | | | | connections to ISP |

Priority-2 Routing

Priority-2 Routing is a special application of call rating information that unit 102 has access to. This information is maintained as part of a subscription service that updates the rate table 102C. Unit 102 makes use of this same information to provide a least-cost reference which may be used in real-time to route offered call traffic. In addition to translating rate information maintained in the a rate table, users of system 102 can be provided with the option of adding their own rate definitions to be used in Priority-2 table lookups.

The Priority-2 Routing table is consulted if and only if all Priority-1 searches failed for any particular call being offered to the system. A single default entry always exists at the end of the Priority-2 table. This entry is defined as “DEFAULT CO OVERFLOW”. Its responsibility is to ensure that an attempt will always be made to carry any call offered to the switch through the CO trunk group serving the local exchange. It is important that unit 102 carry, rather than block calls, regardless of any programming errors made on the part of the administrator.

Custom Rates Plans can only be defined if a Rate Table which in included in the system allows the call type to be determined. This option allows the system adminstrator to define pricing that can be used to select the least-cost route for calls based on dialed digits. The rate plans defined by the administrator are used in addition to any other rate plans included in the Rate Table stored in the system.

| Rate Plan | Call Types |
|---|---|
| User-defined name for this rate | Call types supported for this rate |
| table (tariff) | plan are defined by the Rate Table. |
| | The user enters 3 sets of |
| | information detailed below |
| | addressing these 3 call types: |
| | Intrastate, Interstate and |
| | International. |
| Peak Day Type | Peak Hours |
| Days types when peak | Defined as the hours during |
| rates may be applied: | which peak rates should be |
| Monday-Friday | applied for each type of |
| Saturday | day. Off-Peak Hours are |
| Sunday | defined by default as the |
| Holiday | other hours in the 24-hour |
| | period. |

| Initial Peak | | Overtime Peak | Overtime Peak |
|---|---|---|---|
| Period | Initial Peak Rate | Period | Rate |
| Identifies the | Assigned as | Identifies the | Assigned as units |
| initial period | units (cents) as a | additional periods of | (cents) as a |
| of time used | floating decimal | time following the | floating decimal |
| to measure | (e.g., 0.655) | initial period used to | (e.g., 0.655) |
| the rate of a | | measure the rate of | |
| call carried | | a call carried during | |
| during peak | | peak hour. Periods | |
| hour. | | should be expressed | |
| Periods | | in whole seconds | |
| should be | | (e.g., 60 secs., 6 | |
| expressed in | | secs.). Overtime | |
| whole | | periods are often, | |
| seconds | | but not always | |
| (e.g., 60 | | shorter periods than | |
| secs., 6 | | the initial periods. | |
| secs.) | | As an example, the | |
| | | initial period may be | |
| | | 60 seconds and the | |
| | | overtime period may | |
| | | be 6 seconds. | |
| Initial Off- | Initial Off-Peak | Overtime Off-Peak | Overtime Off- |
| Peak Period | Rate | Period | Peak Rate |
| Identifies the | Assigned as | Identifies the ad- | Assigned as units |
| initial period | units (cents) | ditional periods of | (cents) as a float- |
| of time used | as a floating | time following the | ing decimal (e.g., |
| to measure | decimal (e.g., | initial period used to | 0.655) |
| the rate of a | 0.655) | measure the rate of | |
| call carried | | a call carried during | |
| during off- | | peak hour. Periods | |
| peak hour. | | should be expressed | |
| Periods | | in whole seconds | |
| should be | | (e.g., 60 secs., 6 | |
| expressed | | secs.). | |
| in whole | | Overtime periods | |
| seconds | | are often, but not | |
| (e.g., 60 | | always shorter | |
| secs., 6 | | periods than the | |
| secs.). | | initial periods. As | |
| | | an example, the | |
| | | initial period may be | |
| | | 60 seconds and the | |
| | | overtime period may | |
| | | be 6 seconds. | |

| Rate Plan | Call Type | Peak Day Type | Peak Hours |
|---|---|---|---|
| AT&T Custom | IntraState | Monday-Friday | 8 am-5 pm |
| Tariff | (types 2, 3) | (Note: As a result | |
| | | these are | |
| | | automatically | |
| | | defined as | |
| | | off-peak): | |
| | | Saturday | 12 am-11 pm |
| | | Sunday | 12 am-11 pm |
| | | Holidays | 12 am-11 pm |
| Initial Peak | Initial Peak | Overtime Peak | Overtime Peak |
| Period (secs) | Rate (cents) | Period | Rate |
| 60 | 5 | 6 | 0.5 |
| Initial Off-Peak | Initial Off-Peak | Overtime Off- | Overtime Off-Peak |
| Period | Rate | Peak Period | Rate |
| 60 | 10 | 6 | 1 |
| | Interstate | Monday-Friday | 8 am-5 pm |
| | (types 1, 4) | | |
| Initial Peak | Initial Peak | Overtime Peak | Overtime Peak |
| Period (secs) | Rate (cents) | Period | Rate |
| 60 | 10 | 6 | 1 |
| Initial Off-Peak | Initial Off-Peak | Overtime Off- | Overtime Off-Peak |
| Period | Rate | Peak Period | Rate |
| 60 | 15 | 6 | 1.5 |
| | International | Monday-Friday | 8 am-5 pm |
| | (types 8, 12- | | |
| | 100) | | |
| Initial Peak | Initial Peak | Overtime Peak | Overtime Peak |
| Period (secs) | Rate (cents) | Period | Rate |
| 60 | 25 | 6 | 2.5 |
| Initial Off-Peak | Initial Off-Peak | Overtime Off- | Overtime Off-Peak |
| Period | Rate | Peak Period | Rate |
| 60 | 25 | 6 | 2.5 |

The Priority-2 Routing table makes use of the rate information available from rate table 102C as well as any user-defined rates described in section 4.1 above. The search criteria for Priority-2 routing require tariffs supported by the user to be assigned to a hunt of one or more defined trunk groups.

The Priority-2 table is limited to X number of table entries to be determined by engineering. A minimum of 64 entries is expected to be supported.

| | | Intrastate | Interstate | Int'l. |
|---|---|---|---|---|
| | Associated Trunk | Discount | Discount | Discount |
| Rate Plan | Group(s) | Percentage | Percentage | Percentage |
| Initially | The trunk group | The user | The user | The user |
| provided or | associated with | may elect to | may elect | may elect to |
| user-defined | the rate table | enter a fixed | to enter a | enter a fixed |
| name for this | selected. | percentage | fixed per- | percentage |
| rate table | The list of avail- | discount for | centage | discount for |
| (tariff). This | able trunk groups | all intrastate | discount | all |
| is selected if | is based on the | calls for this | for all in- | international |
| evaluated as | logical groups de- | carrier rate | terstate | calls for this |
| the least cost | fined and avail- | plan. In this | calls for | carrier rate |
| route for the | able in data base | case, the rate | this carrier | plan. In this |
| call based on | 102A. Any given | calculated by | rate plan. | case, the rate |
| the dialed | rate table may | program | In this | calculated by |
| number. | have more than | 102B will be | case, the | program |
| The Rate | one associated | discounted | rate calcu- | 102B ARS |
| Plan is | trunk groups. For | before com- | lated by | will be |
| matched in | example, A | parison to | program | discounted |
| union with | customer | other rates/ | 102B will | before |
| the Call | subscribing to the | plans | be dis- | comparison |
| Type. If | MCI Vision long | available. | counted | to other |
| either | distance plan may | | before | rates/plans |
| matches, the | be carrying long | | compari- | available. |
| associated | distance calls | | son to | |
| trunk group | over multiple | | other | |
| is selected. | MCI T1s. Each | | rates/plans | |
| Defining a | T1 would be de- | | available. | |
| Rate Plan in | fined as a unique | | | |
| a table entry | logical trunk | | | |
| does not re- | group. The MCI | | | |
| quire a cor- | Vision rate table | | | |
| responding | would then be as- | | | |
| Call Type to | sociated to the | | | |
| be defined. | collective group | | | |
| | of T1s. | | | |

Priority-2 Routing Example—Note: this example does not assume that the Priority-1 Table example precedes it.

| Rate Plan | | | | |
|---|---|---|---|---|
| Selected as | | Intrastate | Interstate | Int'l. |
| Least Cost | Associated Trunk | Discount | Discount | Discount |
| Route | Group(s) | Percentage | Percentage | Percentage |
| MCI Vision | Trunk Group 9 - | 8% | 8% | 15% |
| | MCI T1 | | | |
| | Trunk Group 10 - | | | |
| | MCI T1 | | | |
| AT&T Custom | Trunk Group 11 - | | | |
| Tariff | AT&T T1 | | | |
| Custom Tie | Trunk Group 15 - | | | |
| Line | PacBell Tie Line | | | |
| AT&T/LEC | Trunk Group 2 - | | | |
| DDD | PacBell CO | | | |
| | Trunk Group 2 - | | | |
| | PacBell CO | | | |
| | DEFAULT CO | | | |
| | OVERFLOW - | | | |
| | (This is the standard | | | |
| | default to the CO | | | |
| | trunk group for all | | | |
| | call types -- user | | | |
| | cannot remove or | | | |
| | change this as last | | | |
| | choice.) | | | |

Suggested Priority-2 Default Table

A setup wizard can be provided to assist the user in selecting tariffs available in the Rate Table 102C and associating them with trunk groups in the unit 102. The default table identifies overflow to the default CO group (Group 0—COT) for all local + toll calls.

| Rate Plan | | | | |
|---|---|---|---|---|
| Selected as | | Intrastate | Interstate | Intl. |
| Least Cost | Associated Trunk | Discount | Discount | Discount |
| Route | Group(s) | Percentage | Percentage | Percentage |
| | DEFAULT CO | | | |
| | OVERFLOW - | | | |
| | (This is the | | | |
| | standard default to | | | |
| | the CO trunk | | | |
| | group for all call | | | |
| | types -- user | | | |
| | cannot remove or | | | |
| | change this as last | | | |
| | choice.) | | | |

Call Type Override

The Priority-2 table lookup must have the ability to be overridden by a simple call type lookup. The purpose of this table is to allow unit 102 to automatically recognize call types and route traffic accordingly. This can greatly simplify otherwise intricate data entry requirements such as discovering and entering all local prefixes. The Call Type Override requires the Rate Table 102C to be available in unit 102.

| Call Type | | Associated Trunk Group(s) |
|---|---|---|
| Select the call type from the list of possible | | Select one or more trunk |
| call types: | | groups to direct calls |
| 1 | Interstate/InterLATA | matching the call type |
| 2 | Intrastate/InterLATA | selected. The trunk list is |
| 3 | Intrastate/IntraLATA | prioritized top-down. |
| 4 | Interstate/IntraLATA | |
| 5 | Canada | |
| 8 | Puerto Rico | |
| 11 | Local | |
| 12-19 | Caribbean | |
| 20-100 | International | |

Typically ARS programming tables on PBX equipment tend to become obsolete as soon as they have been entered or updated by the technician. Since January 1996, changes to the North American Dialing Plan have accelerated so that is difficult for any service organization to maintain coherent ARS tables in a PBX. With the trend continuing to drive negotiated tariff contracts to a postalized rating structure, one aspect of true cost reduction lies in the ability for the PBX to automatically distinguish between local calls, intrastate calls, interstate calls and international calls.

Companies that provide rate tables commercially are generally capable of automatically updating the national dialing plan information on a frequent (monthly) basis. New local prefixes, NPA splits and overlays, new Caribbean NPAs are all adjusted automatically in the PBX. This relieves the PBX service company and the administrator of the burden of trying to manually update the information.

Call Type Override is the simplest mechanism available to control call routing and reduce costs.

### EXAMPLE

### Call Type Override

| | Associated Trunk |
|---|---|
| Call Type | Group(s) |
| Local (type 11) | Trunk Group 2 - PacBell |
| | CO |
| Intrastate/IntraLATA | Trunk Group 2 - PacBell |
| | CO |

Suggested Default Call Type Override

If Rate Table 102C exists in a system, the default call type override table should select the default CO trunk group 0 as the preferred route for all local and intrastate/intraLATA calls. Most long distance carrier plans do not provide any cost savings on local calls. The COT is the cheapest way to handle this. Mistakes in this programming on a PBX can cost the company in the range of 5 to 15 cents per minute, or more for every misrouted call.

| | Associated Trunk |
|---|---|
| Call Type | Group(s) |
| Local (type 11) | Group 0- COT |
| Intrastate/IntraLATA | Group 0 - COT |

Program 102B has the ability to present the administrator with breakdowns of calls placed to different locations (local, long-distance, int'l.) with actual costs accrued serves as another incentive for rate table subscriptions. The program 102B can also present the administrator with a detailed list of local prefixes (by zone if applicable) is a particularly useful incentive for some of the service providers and equipment providers. The details of the actual reporting program are conventional.

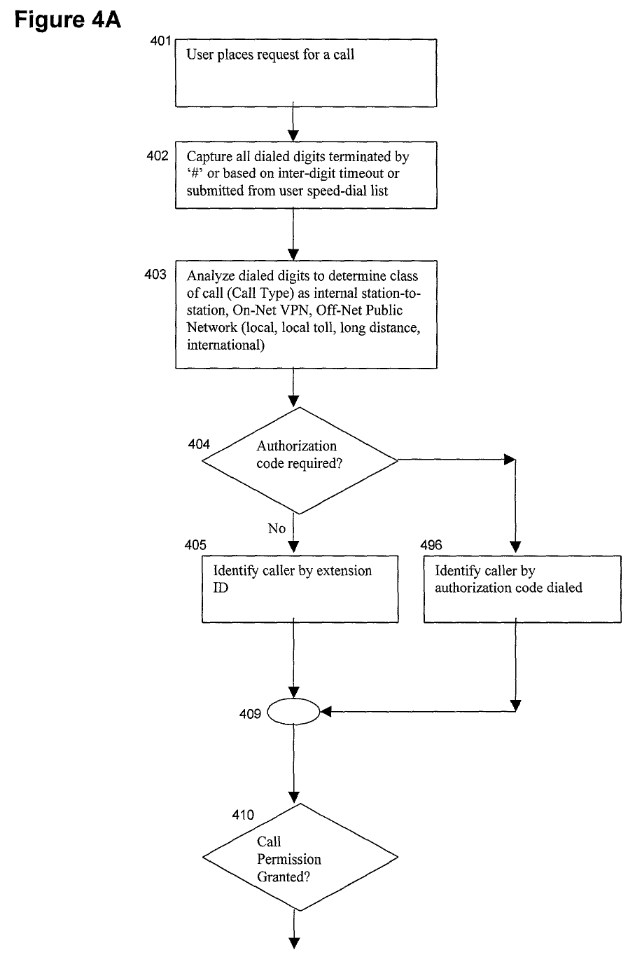

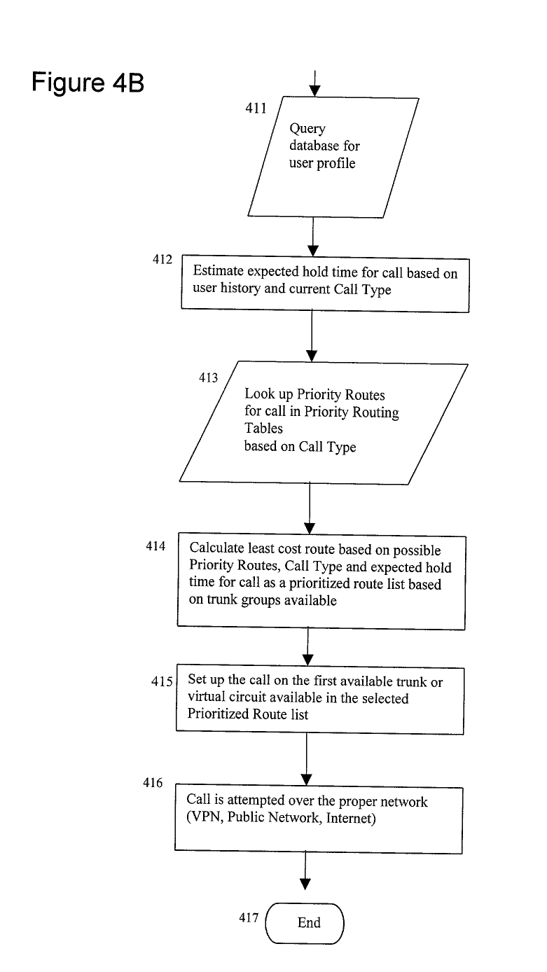

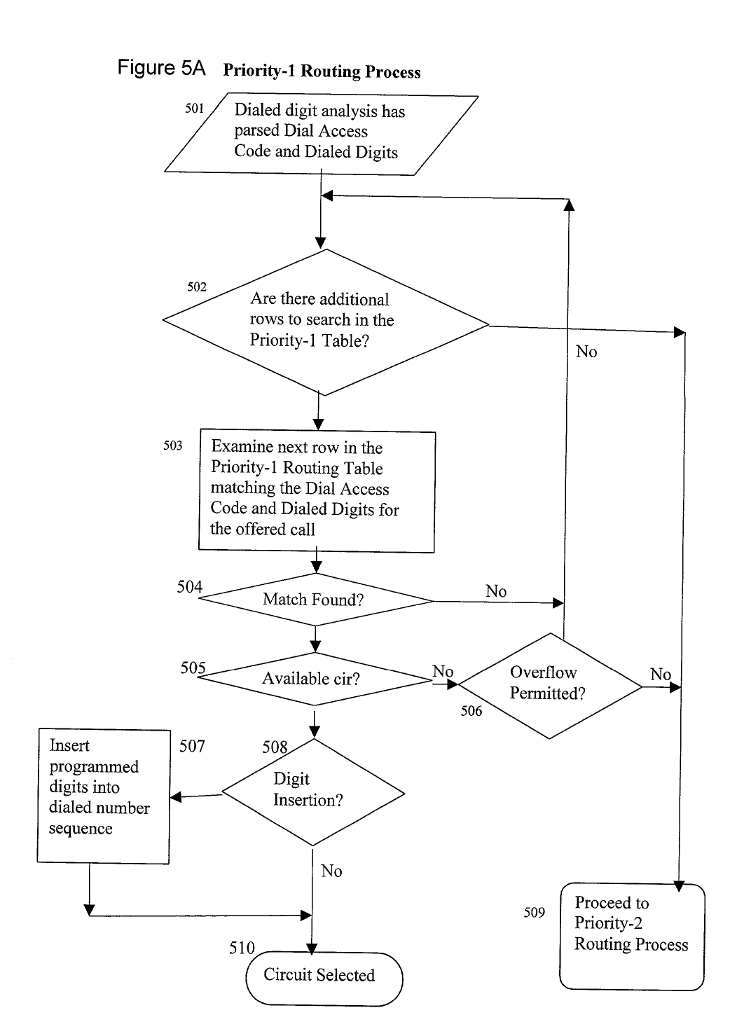

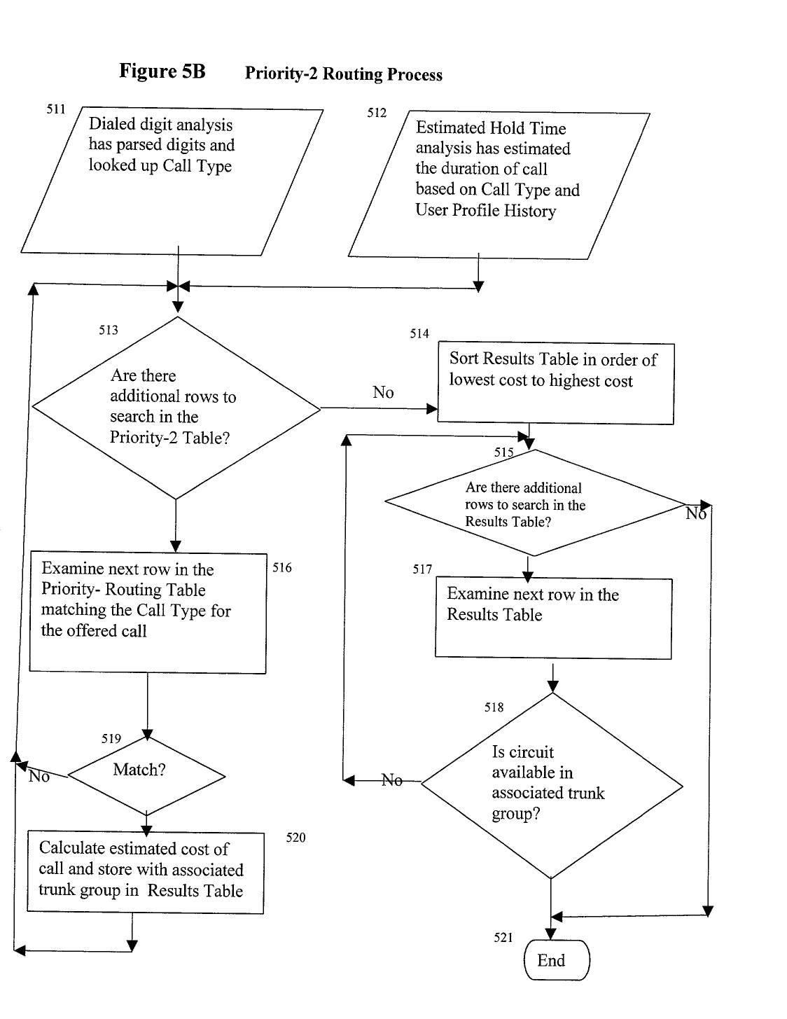

FIGS. 4A, 4B, 5A and 5B provide a more detailed program flow diagram of a program which implements the present invention on a programmable unit 102A.

As indicated by block 401, the process begins when a user places a request for a call. As indicated by block 402 the PBX captures all dialed digits terminated by ‘#’ or based on inter-digit timeout or submitted from user speed-dial list. Next as indicated by block 403 the PBX analyzes the dialed digits to determine the class of call, that is, the Call Type. Calls may be generally classified as internal station-to-station, On-Net VPN, Off-Net Public Network (local, local toll, long distance, international). Block 404 indicates that a check is made to determine if an authorization code is needed for the particular call. At system initialization or at some later time, the system administrator must store a list of calls needing authorization in data base 102A. As indicated by block 405 the PBX can identify the caller by the extension ID. It is noted that each extension is plugged into a different port on unit 102. Alternatively as indicated by block 496, the PBX can identify the caller by the authorization code. Either path leads to block 410 via block 409 and call permission is granted if appropriate.

Next as indicated by block 411 in FIG. 4B, The PBX queries the data base 102A for the user profile. This profile would have been previously generated as indicated in FIG. 3. Using the profile, the system calculates the estimated time for the call as indicated by block 412. The system then looks up Priority Routes for call in Priority Routing Tables based on Call Type as indicated by block 413. As indicated by block 414, the system calculates least cost route based on possible Priority Routes, Call Type and expected hold time for the call as a prioritized route list based on trunk groups available at that time. The system then sets up the call on the first available trunk or virtual circuit available in the selected Prioritized Route list as indicated by block 415. Finally the Call is attempted over the proper network (VPN, Public Network, Internet) and the process ends for that particular call.

FIGS. 5A and 5B are more detailed program block program flow diagrams showing how the system utilizes priority to route calls. The process begins as indicated by block 501 with the system, doing an analysis of the dialed digits including the dialed access code and the other dialed digits. As indicated by blocks 502 and 503, the system examines the rows in the priority-1 routing table until a match is found as indicated by block 504. Block 505 indicates that a check is made to determine if a circuit is available. If no circuit is available and overflow is not permitted as determined by block 506, the process proceeds to priority 2 routing block 509.

If a circuit is available a determination is made as to whether digit insertion is necessary as indicated by block 508. If digit insertion is necessary, the digits are inserted as indicated by block 507. The circuit is then selected as indicated by block 510.

The priority 2 routing process is illustrated in FIG. 5B. The call type is determined as indicated by block 511. As indicated by block 512, the estimated hold time is determined as previously explained. Blocks 513 and 516 indicate that the lines of the priority table are searched until a match is found as indicated by block 519. As indicated by block 514, the results table is sorted in order from the lowest cost to the highest cost. Blocks 515, 517 and 518 indicated that the result table is searched to find an available circuit. When an available circuit is found, the process ends as indicated by block 521.

With the present invention a call can be priced in real-time and this information can be sent to the end-user's telephone station during the call (for example via a related computer terminal). In this way, users would be apprised of actual call costs while on the phone.

It should be noted that while the embodiment of the invention described herein is implemented in the system shown in co-pending application Ser. No. 09/527,968, it should be understood that the invention can be applied to a wide variety of systems that include a programmable PBX. It should also be understood that the present invention can utilize the same principles to classify and route other types of requests for service. For examples, requests for transmission of data can be routed in a similar manner.

While the invention has been shown and explained with respect to preferred embodiments thereof, it should be understood that various changes in form and detail can be made without departing from the sprit and scope of the invention.

I claim:

1) a method of routing telephone calls including the steps of:
gathering information about the typical calling patterns of users,
routing a call based upon both the typical calling pattern of the call's originator and
data in a rate table that specifies the cost of routing calls along specific routes.

2) A system for routing telephone calls including
means for gathering information about the typical calling patterns of users,
means for routing a call based upon both the typical calling pattern of the call's originator and data in a rate table that specifies the cost of routing calls along specific routes.

3) A method of routing calls defined by dialed digits, said method placing calls based upon,
an analysis of the dialed digits,
the cost of the various available routes as specified by rate tables, and
a profile of the user that placed the call whereby the anticipated length of the call is taken into account.

4) The method recited in claim 1 wherein said method includes the alternative of routing said calls via the Internet.

5) The method recited in claim 1 where the call pattern indicates the length of calls made.

6) The system recited in claim 2 wherein said system includes the alternative of routing call via the Internet.

7) The system recited in claim 2 wherein said calling pattern relates to the length of calls made by said caller.

8) The method of routing telephone calls comprising the steps of
storing a rate table which indicates the cost of calls made using various routes,
establishing the priority of various types of calls,
determining the call pattern of the users that place calls,
routing calls based upon a combination of the data in said rate table, the priority of a call and the call pattern of the user who placed the call.

9) A system for routing telephone calls comprising,
a rate table which indicates the cost of calls made using various routes,
a table which specifies the priority of various types of calls,
a program for determining the call pattern of the users that place calls,
a program analyzing the digits of a dialed call to establish the type of the call, and
a program for routing calls based upon a combination of the data in said rate table, the priority of a call and the call pattern of the user who placed the call.

10) The method recited in claim 8 wherein said method includes the alternative of routing said calls via the Internet.

11) The method recited in claim 8 where the call pattern indicates the length of calls made.

12) A method of routing telephone calls comprising the steps of,
analyzing the dialed digits to determine characteristics of the call,
consulting a priority table to establishing a priority for the call,
examining a profile of the callers past calls to establish an anticipated length of the call, and
consulting a rate table based on the priority of the call and the anticipated length of the call to select a route for the call.
